(19) United States
(12) Patent Application Publication
(10) Pub. No.: US 2026/0140958 A1
(43) Pub. Date: May 21, 2026

(54) DYNAMIC DOCUMENT RETRIEVAL IN A RETRIEVAL-AUGMENTED GENERATION SYSTEM

(71) Applicant: Coinbase, Inc., Oakland, CA (US)

(72) Inventor: Yifan Xu, Redmond, WA (US)

(21) Appl. No.: 18/949,932

(22) Filed: Nov. 15, 2024

(51) Int. Cl. G06F 16/2457; G06F 7/08; G06F 16/28

(52) U.S. Cl. CPC G06F 16/24578; G06F 7/08; G06F 16/285

(57) ABSTRACT

Methods, systems, and devices for data management are described. A query response system may receive a user query and query, via data stores storing a corpus of documents, for candidate documents associated with the user query. The query response system may sort the candidate documents based on respective semantic similarities between each candidate document and the user query. The query response system may select a threshold semantic similarity within a range of semantic similarities associated with the sorted candidate documents, where the threshold semantic similarity is selected based on gradient values between adjacent similarities within the range of semantic similarities. The threshold semantic similarity may define a subset of documents to be input to a retrieval augmented response model. The query response system may provide, to the retrieval augmented response model, the user query and the subset of the documents and receive a response to the user query.

### FIELD OF TECHNOLOGY

The present disclosure relates generally to data management, including techniques for dynamic document retrieval in a retrieval-augmented generation (RAG) system.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIG. 1 illustrates an example of a computing environment that supports dynamic document retrieval in a retrieval-augmented generation (RAG) system in accordance with aspects of the present disclosure.

FIG. 2 shows an example of a query response system that supports dynamic document retrieval in a RAG system in accordance with aspects of the present disclosure.

FIGS. 3 and 4 show examples of similarity plots with threshold indexes that support dynamic document retrieval in a RAG system in accordance with aspects of the present disclosure.

FIG. 5 shows an example of a process flow that supports dynamic document retrieval in a RAG system in accordance with aspects of the present disclosure.

FIG. 6 shows a block diagram of an apparatus that supports dynamic document retrieval in a RAG system in accordance with aspects of the present disclosure.

FIG. 7 shows a block diagram of a query response system that supports dynamic document retrieval in a RAG system in accordance with aspects of the present disclosure.

FIG. 8 shows a diagram of a system including a device that supports dynamic document retrieval in a RAG system in accordance with aspects of the present disclosure.

FIGS. 9 and 10 show flowcharts illustrating methods that support dynamic document retrieval in a RAG system in accordance with aspects of the present disclosure.

### DETAILED DESCRIPTION

A retrieval-augmented generation (RAG) system may retrieve a quantity of documents for input to a large language model (LLM). For example, a RAG system may retrieve the quantity of documents based on relevance of documents in one or more document stores to a query. The RAG system may provide the retrieved quantity of documents as input to the LLM, which may produce a response to the query based on content within the document. In other words, the RAG system may provide query responses via an LLM that generates the query responses using the content of the documents identified by the RAG system as being relevant to the query. In some cases, the RAG system may retrieve a static quantity of documents (e.g., static k documents). That is, the RAG system may retrieve, regardless of the query, a fixed quantity of documents (e.g., top-k documents) based on relevance of the documents to the query. In such cases, the RAG system may retrieve a same quantity of documents for a relatively simple query and a relatively complex query. However, a fixed quantity of documents may result in limited coverage of relevant documents for complex queries and over coverage for simple queries.

As described herein, a RAG system may retrieve a dynamic quantity of documents for a received user query. For example, the RAG system may rank candidate documents according to semantic similarities to the received user query and identify a threshold semantic similarity within the sorted semantic similarities. The RAG system may identify the threshold semantic similarity based on gradient values between adjacent semantic similarities, such as between individual documents sorted according to semantic similarity or between clusters of documents sorted according to semantic similarity. The RAG system may provide documents that have semantic similarities within the identified threshold semantic similarity to an LLM along with the received user query. The LLM may generate a response to the user query based on the provided documents.

By selecting a dynamic quantity of documents for input to the LLM, the RAG system may support provision of user query responses that are appropriate for a complexity level of a given user query. Selecting a low quantity of documents relative to a complexity level of a user query may be associated with generation of an inaccurate response by the LLM, such as due to hallucination based on having incomplete or skewed data. Alternatively, selecting a high quantity of documents relative to a complexity level of the user query may be associated with high computational resource costs and generation of overcomplicated responses, including responses that are verbose and dilute the information actually sought out by the user query. Accordingly, by dynamically selecting a retrieved quantity of documents that aligns with the complexity of the user query, techniques described herein may improve accuracy and reduce computational resource costs relative to RAG systems that implement static quantities of retrieved documents. As an example, for a relatively simple user query, the RAG system may reduce the computational complexity by retrieving relatively fewer documents, while, for a relatively complex user query, the RAG system may provide a more accurate response by retrieving relatively more documents.

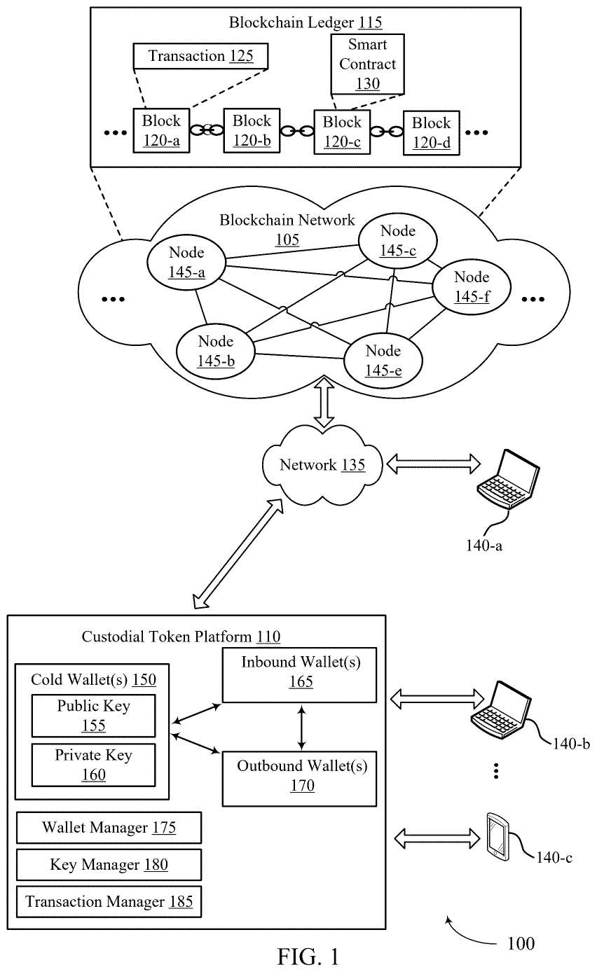

FIG. 1 illustrates an example of a computing environment 100 that supports dynamic document retrieval in a RAG system in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the custodial token platform 110, the blockchain network 105, or both. For example, a user of the computing device 140-a may provide user inputs via the computing device 140-a, which may result in commands, data, or any combination thereof being communicated via the network 135 to the custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols may have layer two and layer two functionality, and each layer may support or utilize different tokens. Layer one may refer to the underlying main blockchain architecture, and layer one solutions are improvements directly integrated into the codebase of a cryptocurrency's main blockchain. Layer one solutions, on the other hand, are built on top of layer one and may interact with the main blockchain but have their own architecture. Layer two solutions may support offload of processing from the main blockchain (layer one) to improve scalability and speed while retaining the robust security of the main chain. Additionally, smart contracts implemented on the blockchain networks may support different types of tokens, and the code of the mart contracts may control how tokens are spent, who can spend the tokens, and other conditions for transfer. Additionally, one or more smart contracts may support a decentralized application (“Dapp”) that facilitate various types of functionality. Accordingly, various types of tokens may be supported by a blockchain network.

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital assets between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to an external wallet, to deploy a smart contract (e.g., a self-executing program), or to call a smart contract.

In some cases, RAG systems may retrieve static quantities of documents. For example, a RAG system may retrieve a fixed quantity of documents regardless of characteristics of a query, including query complexity and quantities of documents relevant to the query. In some other cases, RAG systems may retrieve dynamic quantities of documents. Retrieving dynamic quantities of documents may improve precision and efficiency and retrieval systems by retrieving a quantity of documents that is in accordance with characteristics of the query and relative relevance of documents. As an example, RAG systems may improve efficiency by dynamically reducing a quantity of retrieved documents, improve an accuracy of generated responses by dynamically increasing a quantity of retrieved documents, or the like. Some RAG systems may support dynamic retrieval by performing additional model training (e.g., relative to other RAG systems), deploying classifiers, or both. However, the additional training and deployment of classifiers may introduce resource and processing overhead as well as increase model complexity. Other RAG systems may support dynamic retrieval by iteratively calling LLMs for decision making. That is, some RAG systems may input candidate documents to an LLM, where the LLM may determine dynamic quantities of relevant documents for a given query. However, using the LLM for decision making may increase computational resources and latency.

As described herein, a RAG system may retrieve a dynamic quantity of documents for a user query. For example, the RAG system may rank candidate documents according to semantic similarities to the user query and identify a threshold semantic similarity within the sorted semantic similarities. The RAG system may identify the threshold semantic similarity based on gradient values between adjacent semantic similarities, such as between individual documents sorted according to semantic similarity or between clusters of documents sorted according to semantic similarity. The RAG system may provide documents that have semantic similarities within the identified threshold semantic similarity to an LLM along with the received user query. The LLM may generate a response to the user query based on the provided documents.

The RAG system may be implemented in the custodial token platform 110. For example, the custodial token platform 110 may support a query response system (e.g., a chat bot or artificial intelligence (AI) program including a RAG system) that retrieves documents, inputs the retrieved documents into an LLM, and provides the response generated by the LLM to the user. The custodial token platform 110 may display a user interface of the query response system on the computing device, such as via a website or application on the computing device. It should be understood that the RAG system described herein may be used in other contexts separate from the custodial token platform 110.

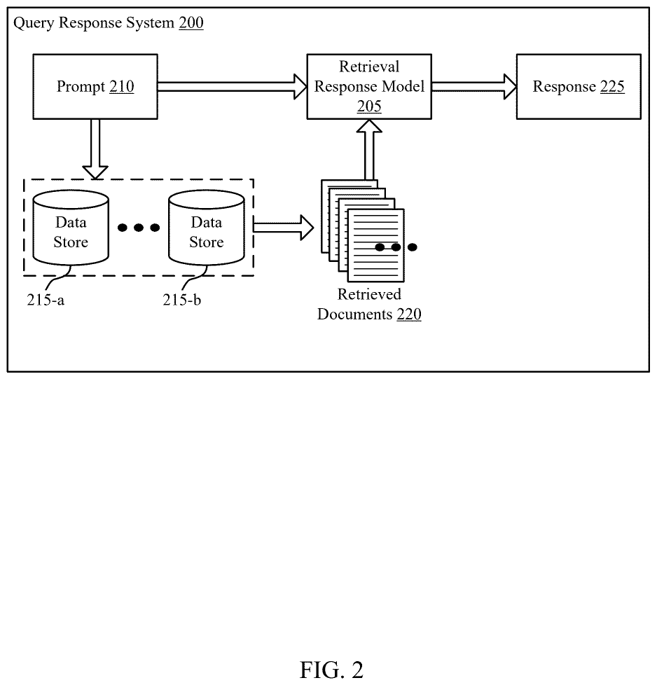

FIG. 2 shows an example of a query response system 200 that supports dynamic document retrieval in a RAG system in accordance with aspects of the present disclosure. The query response system 200 may implement or be implemented by aspects of the computing environment 100 as described with reference to FIG. 1. For example, the query response system 200 may run on or be accessible via a computing device 140. Additionally, or alternatively, the query response system 200 may be a system of the custodial token platform 110.

The query response system 200 may be an example of a RAG system. For example, the query response system 200 may improve performance of an LLM, such as a retrieval response model 205, by providing updated, relevant information. In other words, the query response system 200 may improve performance of the retrieval response model 205 (e.g., an LLM) by integrating real-time information retrieval from external sources (e.g., data sources), which may be more up-to-date and accurate relative to static data used to train the retrieval response model.

In the example of FIG. 2, the query response system 200 may retrieve documents from one or more data stores, including a data store 215-a through a data store 215-b. While two data stores are shown in the example of FIG. 2, it may be understood that the query response system 200 may retrieve documents from any number of data stores. The data store 215-a through the data store 215-b may store a corpus of documents. In some examples, the documents may include multiple types of information, including application programming interfaces (APIs). That is, information in the data stores may include documentation describing or encompassing one or more APIs. The APIs may be related to or supported by the custodial token platform 110 as described with reference to FIG. 1 or may related to or supported by other types of systems or platforms.

The query response system 200, based on receiving a prompt 210, may retrieve documents (e.g., a subset of documents) from the data store 215-a through the data store 215-b. Retrieving the documents may involve multiple operations, including ranking the documents from the data store 215-a through the data store 215-b according to similarity with the prompt 210, selecting a dynamic threshold selection algorithm, and applying the selected dynamic threshold selection algorithm.

The query response system 200 may query the data store 215-a through the data store 215-b for a relatively large quantity of documents (e.g., compared to a quantity of documents relevant to the prompt 210). In other words, the query response system 200 may query one or more data stores for multiple candidate documents associated with the prompt 210. In some examples, the query response system 200 may query a vector database retrieval engine for the multiple candidate documents. That is, the vector database retrieval engine may receive the query from the query response system 200, vectorize the query, and respond to the query with the multiple candidate documents based on vector similarities between the vectorized query and vectors generated based on the documents.

The multiple candidate documents may be ranked or sorted according to similarity with the prompt 210. For example, the query response system 200 may obtain a ranking of the multiple candidate documents by calculating a semantic similarity of each document of the multiple candidate documents to the prompt 210 and sorting the documents from most similar to least similar. Alternatively, the vector database retrieval engine may return the multiple candidate documents to the query response system 200 in ascending order of similarity. In other words, the query response system 200 may perform the ranking or receive the ranking from the vector database retrieval engine.

The semantic similarities of each document to the prompt 210 may refer to vector similarity. That is, each document and the prompt 210 may be represented by embedded vectors, which may be compared through a cosine similarity or a dot product. In other words, the query response system 200 (e.g., or the vector database retrieval engine) may calculate the semantic similarities of each document with the prompt 210 using a cosine similarity or a dot product between respective document vector embeddings and the prompt 210 vector embedding. The calculated semantic similarities may be sorted in ascending order (e.g., of distances to the prompt 210). That is, the query response system 200 may sort the candidate documents from most similar to the prompt 210 to least similar to the prompt 210 according to the calculated semantic similarities.

The query response system 200 may apply a gradient algorithm or a cluster algorithm to identify a cut-off point within the multiple candidate documents. That is, the query response system 200 may identify a threshold semantic similarity within a range of semantic similarities of the sorted candidate documents using an algorithm. The query response system 200 may output a subset of documents of the multiple candidate documents that are within the threshold semantic similarity. In other words, the subset of documents may have semantic similarities that are at least as similar (or more similar than) the threshold semantic similarity. The threshold semantic similarity may define the retrieved documents 220 that are to be input to the retrieval response model 205 for generation of a response 225.

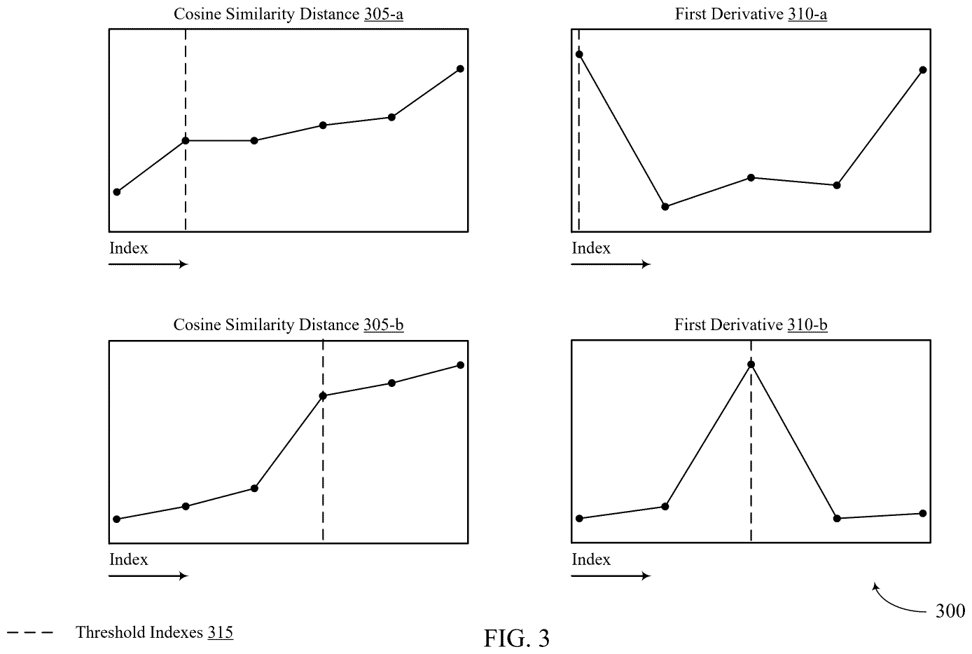

The gradient algorithm may use first-order derivatives to analyze changes in sorted semantic similarities (e.g., similarity distances) and identify cut-off points in scenarios with relatively few retrieval candidates. The gradient algorithm may support precise document selection by identifying sharp changes in document relevance. The gradient algorithm may be described in greater detail elsewhere herein, including with reference to FIG. 3.

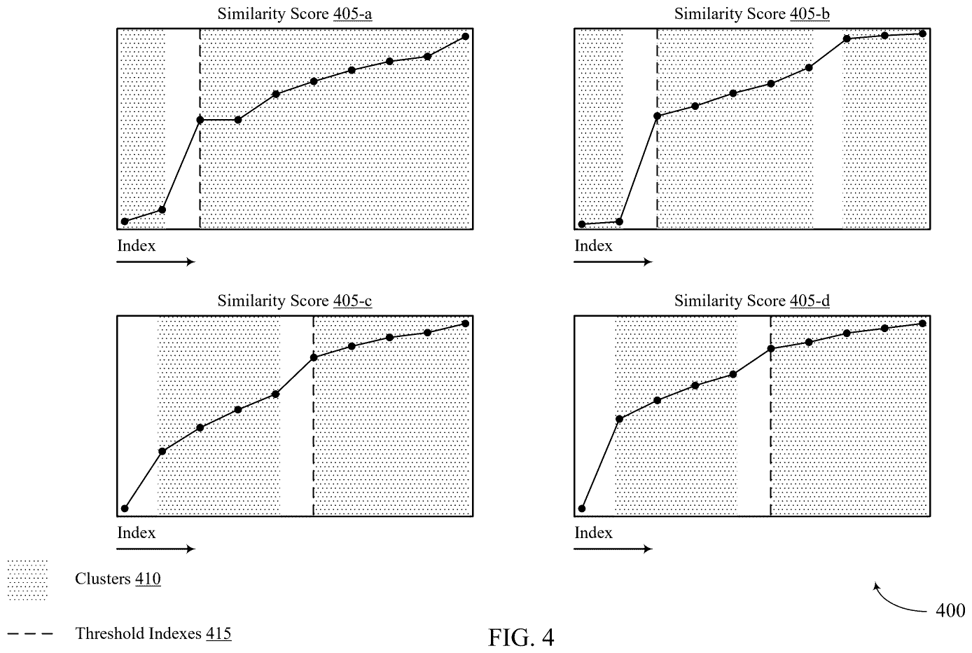

The cluster algorithm may group similar candidate documents within sorted semantic similarities. The cluster algorithm may support complex analyses with relatively large quantities of retrieval candidates. Additionally, the cluster algorithm may support nuanced and flexible retrieval in multi-modal examples, accommodating multiple shifts in document relevance. The cluster algorithm may be described in greater detail elsewhere herein, including with reference to FIG. 4.

The query response system 200 may determine whether to use the gradient algorithm or the cluster algorithm based on a quantity of retrieval candidates. For example, the query response system 200 may apply the gradient algorithm in examples in which the quantity of candidate documents is below a threshold (e.g., for relatively small quantities of candidate documents). Alternatively, the query response system 200 may apply the cluster algorithm in examples in which the quantity of candidate documents is above a threshold (e.g., for relatively large quantities of candidate documents).

In some examples, the query response system 200 may perform multi-reference tasks. That is, the multiple candidate documents may include multiple references from a same API. In such examples, the query response system 200 may perform deduplication to remove the multiple reference such that a single reference to the API is included in the quantity of candidate documents. The query response system 200 may perform the deduplication prior to determining whether to use the gradient algorithm or the cluster algorithm. For example, the query response system 200 may perform the deduplication prior to algorithm selection such that the quantity of candidate documents reflects single references to one or more APIs of the multiple candidate documents.

After determining the threshold semantic similarity, the query response system 200 may provide retrieved documents 220 defined by the threshold semantic similarity and the prompt 210 to the retrieval response model 205. The retrieval response model 205 may generate the response 225 to the prompt based on the retrieved documents 220 and the prompt 210. The query response system 200 may obtain the response 225 to the prompt 210.

Techniques described herein may be used in combination with a re-ranking of the initially retrieved documents. For example, the query response system 200 may re-rank or reorder the candidate documents initially retrieved from the data store 215-a through the data store 215-b. In such examples, re-ranking may improve the retrieval process by reducing data volume and improving relevance of documents that proceed to other operations in the query response system 200. The query response system 200 may perform the re-ranking after or before retrieving the documents from the data stores (e.g., prior to applying an algorithm, including the gradient algorithm or the cluster algorithm).

Additionally, or alternatively, the query response system 200 may implement one or more other processes in combination with the gradient or cluster algorithms, including vector embedding length (e.g., using longer embeddings), chunking strategies (e.g., breaking down large datasets), custom embedding (e.g., tailoring embeddings to domain requirements), query transformation, metadata filtering (e.g., using additional data for context), GraphRAG (e.g., a graph-based knowledge representation), or the like.

FIG. 3 shows examples of similarity plots 300 that support dynamic document retrieval in a RAG system in accordance with aspects of the present disclosure. The similarity plots 300 may implement or be implemented by aspects of the computing environment 100, the query response system 200, or both. For example, the similarity plots 300 may represent sorted (e.g., indexed) semantic similarities of documents retrieved from one or more data stores, such as the data stores 215 as described with reference to FIG. 2. Documents before the threshold indexes in each of the similarity plots 300 may be examples of retrieved documents, such as the retrieved documents 220 as described with reference to FIG. 2.

The similarity plots 300 may include threshold indexes 315 that are selected in accordance with a gradient algorithm. The gradient algorithm may include calculating a first derivative of similarity distances between documents having adjacent semantic similarities. In other words, the gradient algorithm may include calculating a gradient between documents having adjacent semantic similarities within multiple documents sorted according to semantic similarities (e.g., in ascending order). The gradient algorithm may highlight transitions in document relevance by measuring a rate of change in semantic similarities between consecutive (e.g., adjacent) documents.

The similarity plots 300 may include plots of cosine similarity distances that correspond to plots of first derivatives. For example, a cosine similarity distance 305-a plot may correspond to a first derivative 310-a plot, and a cosine similarity distance 305-b plot may correspond to a first derivative 310-b plot. While the similarity plots described with reference to FIG. 3 are cosine similarities, it may be understood that other similarity metrics may be plotted, including dot product similarities.

In accordance with the gradient algorithm, a RAG system may select the threshold indexes 315 (e.g., threshold semantic similarity) as a position where the first derivative reaches a maximum (e.g., argmax). The threshold indexes 315 may represent a threshold at which the documents transition from being relevant to a query to less relevant to the query. Selecting the threshold indexes 315 may ensure that most pertinent documents are considered for a query, which may improve precision and relevance of query responses.

The gradient algorithm may be applied in examples in which a quantity of candidate documents is limited (e.g., below a threshold) or where there is a distinct, sharp change in the semantic similarities. That is, the gradient algorithm may be applied in examples in which a first derivative plot includes a single relative maximum, including in the example of the first derivative 310-b plot.

An example of the gradient algorithm is as follows:

| 1: | Input: Query string q, number of initial results k | |
|---|---|---|
| 2: | Output: Subset of search results R, cutoff point C | |
| 3: | procedure SearchAPI(q, k) | |
| 4: | results ← Search(q, k) | [symbol] Retrieve initial search results |
| 5: | Extract and deduplicate paths from results to form D [symbol] Prepare clean result set | |
| 6: | Sort D by their associated distances | [symbol] Order results by relevance |

measure

| 7: | if \|D\| ≥ 2 then | |
|---|---|---|
| 8: | Let Gᵢ = Dᵢ₊₁ − Dᵢ for i = 1, . . ,\|D\| − 1 | [symbol] Compute gradients as first- |

order differences

| | | |
|---|---|---|
| 9: | C ← argmaxᵢGᵢ + 1 | [symbol] Identify the position of the largest gradient as |

cutoff

| 10: | else | |
|---|---|---|
| 11: | C ← 1 | [symbol] Default to single result if insufficient data |
| 12: | end if | |
| 13: | R ← D[1:C] | [symbol] Select results up to the cutoff |

| | |
|---|---|
| 14: | return R, C |
| 15: | end procedure |

FIG. 4 shows examples of similarity plots 400 that support dynamic document retrieval in a RAG system in accordance with aspects of the present disclosure. The similarity plots 400 may implement or be implemented by aspects of the computing environment 100, the query response system 200, or both. For example, the similarity plots 400 may represent sorted (e.g., indexed) semantic similarities of documents retrieved from one or more data stores, such as the data stores 215 as described with reference to FIG. 2. Documents before the threshold indexes 415 in each of the similarity plots 400 may be examples of retrieved documents, such as the retrieved documents 220 as described with reference to FIG. 2.

The similarity plots 400 may include threshold indexes 415 that are selected in accordance with a cluster algorithm. The cluster algorithm may involve analyzing semantic distances between document candidates in a retrieval set by grouping documents into clusters based on respective semantic similarities. For example, the cluster algorithm may involve segmenting ranked candidate documents into groups based on semantic similarities. In other words, a RAG system may organize ranked candidate documents into clusters or plateaus where each group represents a range of documents having similar relevance to the query. That is, candidate documents within a same cluster may have similar semantic similarities to the query relative to other candidate documents. The clustering may capture nuances in document relevance and accommodate complex patterns in large datasets (e.g., multi-modality). By identifying the clusters 410, the cluster algorithm may map out a landscape of document relevance, providing a view of how the clusters 410 are distributed within a set of retrieved documents. The cluster algorithm may be an example of an HDBSCAN, OPTICS, DBSCAN, or KMeans clustering algorithm.

After the clusters 410 are formed, the cluster algorithm may involve identifying plateaus. For example, the RAG system may identify regions within the ordered semantic similarities where clusters of similar documents occur. Each plateau may represent a cohesive group of semantically similar documents. Boundaries between plateaus may be candidate threshold indexes. That is, the threshold indexes 415 may be selected at plateau boundaries. The RAG system may select the threshold indexes 415 to include multiple documents relevant to the query while excluding documents having less relevance to the query. Identifying the plateaus may be associated with improved performance of the RAG system, including improved granularity and precision of document retrieval. The RAG system may identify the plateaus in scenarios with multiple shifts in relevance between candidate documents (e.g., multi-modal similarity plots, such as plots with multiple relative maxima).

The RAG system may select the threshold indexes 415 based on cluster analysis. Selection of threshold indexes 415 may be based on transitions between the clusters 410. For example, the RAG system may select the threshold indexes 415 where relevance to the query significantly diminishes. That is, the RAG system may select the threshold indexes 415 where there are relatively large changes in similarity scores between adjacent clusters, such as relatively large compared to other cluster boundaries or exceeding a threshold. The threshold indexes 415 may correspond to a boundary at an edge of a cluster having relatively more relevance to the query compared to one or more other clusters. In some examples, the RAG system may select the threshold indexes 415 by identifying an end of a plateau with relatively more similarity to the query or a beginning or a plateau with a drop in similarity to the query.

The similarity plots 300 may include plots of cosine similarities or dot product similarities of candidate documents to the query. For example, points on a similarity score 405-a plot, a similarity score 405-b plot, a similarity score 405-c plot, and a similarity score 405-d plot may represent semantic similarities of candidate documents to the query sorted from most similar (e.g., smallest “distance” to the query) to least similar.

An example of the cluster algorithm is as follows:

| 1: | Input: Query string q, number of initial results k | |
|---|---|---|
| 2: | Output: Subset of search results R, cutoff point C | |
| 3: | procedure SearchAPI(q, k) | |
| 4: | results ← Search(q, k) | [symbol] Retrieve initial search results |
| 5: | distances ← ExtractDistances(results) | [symbol] Extract distances from |

results

| | | |
|---|---|---|
| 6: | X ← {(i, distances[i]):i ∈ {1,.,\|distances\|}} | [symbol] Prepare index- |

distance pairs

| | | |
|---|---|---|
| 7: | Normalize X using a standard scaling approach | [symbol] Standardize feature |

vector

| | |
|---|---|
| 8: | Apply clustering (e.g., HDBSCAN, OPTICS) to X to obtain labels [symbol] Cluster |

data into groups

| | |
|---|---|
| 9: | Identify contiguous regions with consistent labels as plateaus [symbol] Detect stable |

clusters

| | |
|---|---|
| 10: | Compute gradients G ← {distances[i + 1] − distances[i]:i ∈ |

| | |
|---|---|
| {1, . . ,\|distances\| − 1}} | [symbol] Calculate gradients |

| | | |
|---|---|---|
| 11: | C ← argmax(G) + 1 | [symbol] Determine the largest gradient as cutoff |

| | | |
|---|---|---|
| 12: | R ← results[1:C] | [symbol] Select results up to cutoff |

| | | |
|---|---|---|
| 13: | return R, C | [symbol] Return optimized results and cutoff point |

| | |
|---|---|
| 14: | end procedure |

Another example of a cluster algorithm in which clustering parameters are set automatically is as follows:

| 1: | Input: Query string q, number of initial results k | |
|---|---|---|
| 2: | Output: Subset of search results R, cutoff point C | |
| 3: | procedure SearchAPI(q, k) | |
| 4: | results ← Search(q, k) | [symbol] Retrieve initial search results |
| 5: | distances ← ExtractDistances(results) | [symbol] Extract distances from |

results

| | | |
|---|---|---|
| 6: | X ← {(i, distances[i]):i ∈ {1,.,\|distances\|}} | [symbol] Prepare index- |

distance pairs

| | | |
|---|---|---|
| 7: | Normalize X using a standard scaling approach | [symbol] Standardize features for |

clustering

| | | |
|---|---|---|
| 8: | Optimize Clustering Parameters: | [symbol] Parameter optimization for |

clustering

| | | |
|---|---|---|
| 9: | n_samples ← \|X\| | [symbol] Total number of samples |
| 10: | Define parameter ranges based on n_samples | [symbol] Adjust ranges based on sample |

size

| | | |
|---|---|---|
| 11: | min_cluster_sizes ← [2, 3, 4, 5] | [symbol] Possible minimum cluster sizes |

| | | |
|---|---|---|
| 12: | min_samples_hd ← [1,2, 3] | [symbol] Minimum samples for HDBSCAN |
| 13: | min_samples_op ← [2, 3, 4] | [symbol] Minimum samples for OPTICS |

| | | |
|---|---|---|
| 14: | xi_values ← [2, 3, 4] | [symbol] Xi values for OPTICS |
| 15: | best_score ← −∞ | [symbol] Initialize the best score |

| 16: | best_params ← None | [symbol] Initialize the best parameters |
|---|---|---|
| 17: | for all (mcs, ms_hd, ms_op, xi) in combinations of parameter values do | |
| 18: | Apply HDBSCAN with mcs, ms_hd [symbol] Clustering with HDBSCAN | |
| 19: | Apply OPTICS with ms_op, xi [symbol] Clustering with OPTICS | |
| 20: | Compute silhouette scores for both | [symbol] Evaluate clustering quality |

| | |
|---|---|
| 21: | Compare silhouette scores and select labels from algorithm with higher score |

[symbol]

Choose better clustering

| | | |
|---|---|---|
| 22: | Update best_params if current configuration is better | [symbol] Select |

optimal parameters

| 23: | end for | |
|---|---|---|
| 24: | if best_params is None then | |
| 25: | Use default parameters | [symbol] Fallback to default if no optimal found |
| 26: | end if | |
| 27: | Apply Clustering: | [symbol] Use optimal parameters to label data |

| | | |
|---|---|---|
| 28: | Identify contiguous regions with consistent labels as plateaus | [symbol] Detect plateau |

regions in clusters

| | |
|---|---|
| 29: | Compute gradients G ← {distances[i + 1] − |

| | |
|---|---|
| distances[i]: iin{1,.,\|distances\| − 1}} | [symbol] Calculate gradients |

between points

| | | |
|---|---|---|
| 30: | C ← argmax(G) + 1 | [symbol] Determine the optimal cutoff |
| 31: | R ← results[1:C] | [symbol] Select results up to the cutoff |

| | | |
|---|---|---|
| 32: | return R, C | [symbol] Return the optimized subset and cutoff point |

| | |
|---|---|
| 33: | end procedure |

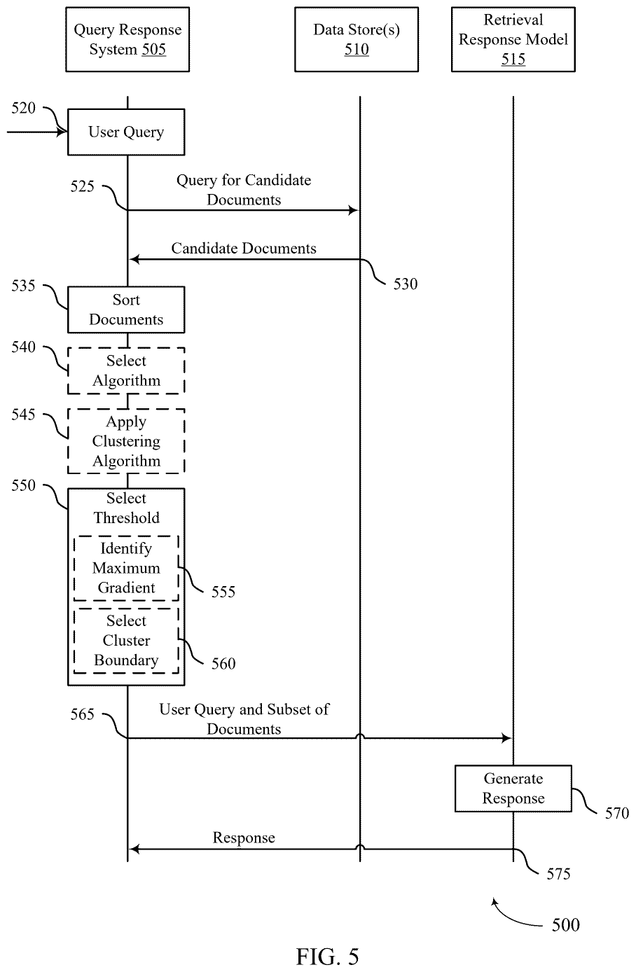

FIG. 5 shows an example of a process flow 500 that supports dynamic document retrieval in a RAG system in accordance with aspects of the present disclosure. The process flow 500 may implement or be implemented by the computing environment 100, the query response system 200, the similarity plots 300, the similarity plots 400, or any combination thereof. For example, the process flow 500 may include a query response system 505, data store(s) 510, and a retrieval response model 515, which may be examples of the corresponding devices or systems as described with reference to FIG. 2.

Alternative examples of the following may be implemented, where some operations are performed in a different order than described or are not performed at all. In some examples, operations may include additional features not mentioned below, or further operations may be added. Although the query response system 505, the data store(s) 510, and the retrieval response model 515 are shown performing the operations of the process flow 500, some aspects of some operations may also be performed by one or more other components.

At 520, the query response system 505 may receive a user query. The user query may be an example of the prompt 210 as described with reference to FIG. 2.

At 525, the query response system 505 may query for candidate documents. For example, the query response system 505 may query the data store(s) 510 for candidate documents associated with the user query. In other words, the query response system 505 may query, via the data store(s) 510 (e.g., one or more data stores) storing a corpus of documents, for multiple candidate documents associated with the user query. The multiple candidate documents may include one or more APIs. At 530, the data store(s) 510 may provide the candidate documents. In some examples, the query response system 505 may obtain document chunks corresponding to raw or unprocessed documents at the data store(s) 510. That is, the query response system 505 may obtain or generate the document chunks based on initial data sources in the data store(s) 510. The document chunks may be examples of smaller, more manageable chunks of documents within the data store(s) 510. In other words, the document chunks may be examples of preprocessed documents.

At 535, the query response system 505 may sort the documents. That is, the query response system 505 may sort the multiple candidate documents based on respective semantic similarities between each candidate document of the multiple candidate documents and the user query. For example, the query response system may sort for a first time or re-sort the candidate documents obtained from the data store(s) 510. In examples in which the data store(s) 510 provide the candidate documents sorted based on similarity to the query, the query response system 505 may re-sort the candidate documents. Alternatively, the query response system 505 may sort the candidate documents for a first time. The candidate documents may be sorted in ascending order based on similarity to the user query. The semantic similarities may include cosine similarities or dot products between respective documents of the multiple candidate documents and a query embedding of the user query.

At 540, the query response system 505 may select an algorithm. That is, the query response system 505 may select a first threshold selection algorithm or a second threshold selection algorithm based on a quantity of the multiple candidate documents. For example, the query response system 505 may select a gradient algorithm or a clustering algorithm, which may be described in greater detail with reference to FIGS. 3 and 4, respectively.

At 545, the query response system 505 may apply a clustering algorithm. For example, the query response system 505 may apply a clustering algorithm to multiple semantic similarities of the range of semantic similarities, where the clustering algorithm generates two or more clusters of one or more candidate documents of the multiple candidate documents, each of the two or more clusters having semantic similarities within a respective threshold semantic similarity. The query response system 505 may apply the clustering algorithm based on selecting the clustering algorithm at 540.

At 550, the query response system 505 may select a threshold. For example, the query response system 505 may select a threshold semantic similarity within a range of semantic similarities associated with the sorted multiple candidate documents. The threshold semantic similarity may be selected based on one or more gradient values between two adjacent respective similarities within the range of semantic similarities. The threshold semantic similarity may define a subset of documents, of the multiple candidate documents, to be input to a retrieval augmented response model. The threshold semantic similarity may be an example of the threshold indexes 315 or the threshold indexes 415 as described with reference to FIGS. 3 and 4, respectively.

At 555, the query response system 505 may identify a maximum gradient. For example, the query response system 505 may select the threshold semantic similarity based on a maximum gradient value among gradient values between pairs of adjacent respective similarities within the range of semantic similarities. Selecting the maximum gradient value may be in accordance with the gradient algorithm. That is, the query response system 505 may identify the maximum gradient based on selecting the gradient algorithm at 540. In some examples, the maximum gradient value is used for selection of the threshold semantic similarity based on a quantity of the plurality of candidate documents being below a threshold quantity. The maximum gradient value may be an example of a maximum on a first derivative plot, such as the first derivative 310-a plot or the first derivative 310-b plot as described with reference to FIG. 3.

At 560, the query response system 505 may select a cluster boundary. For example, the query response system 505 may select the threshold semantic similarity based on a boundary between two clusters of the two or more clusters of one or more candidate documents. That is, the query response system 505 may select the threshold semantic similarity as a cluster boundary in examples in which the query response system 505 selects the clustering algorithm at 540 and applies the clustering algorithm at 545. The boundary for the threshold semantic similarity may be based on a maximum difference of semantic similarities between adjacent clusters of the two or more clusters. The cluster boundary may be an example of the threshold indexes 415 as described with reference to FIG. 4.

At 565, the query response system 505 may input, to the retrieval response model 515, a user query and subset of documents. That is, the query response system 505 may provide, to the retrieval response model 515 (e.g., a retrieval augmented response model), the user query and the subset of the documents defined by the threshold semantic similarity.

At 570, the retrieval response model 515 may generate a response. The retrieval response model 515 may be an example of an LLM. In some examples, the response to the user query may be associated with a higher accuracy level, generated using reduced processing complexity, or both compared to an accuracy level, a processing complexity, or both of a different response generated using a static threshold semantic similarity.

At 575, the query response system 505 may receive the response. That is, the query response system 505 may receive, from the retrieval response model 515, a response to the user query. The query response system 505 may, in some examples, display the response to the user query via a user interface of the query response system 505, such as via a user interface of a client application or a web browser of the query response system 505.

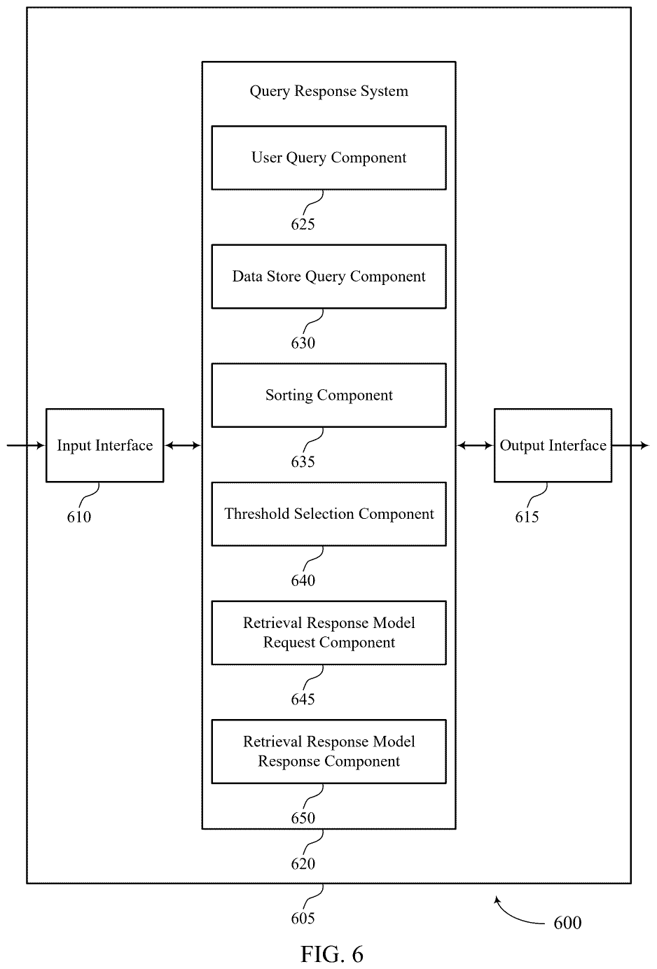

FIG. 6 shows a block diagram 600 of a system 605 that supports dynamic document retrieval in a RAG system in accordance with aspects of the present disclosure. The system 605 may include an input interface 610, an output interface 615, and a query response system 620. The system 605, or one or more components of the system 605 (e.g., the input interface 610, the output interface 615, the query response system 620), may include at least one processor, which may be coupled with at least one memory, to support the described techniques. Each of these components may communicate, directly or indirectly, with one another (e.g., via one or more buses, communications links, communications interfaces, or any combination thereof).

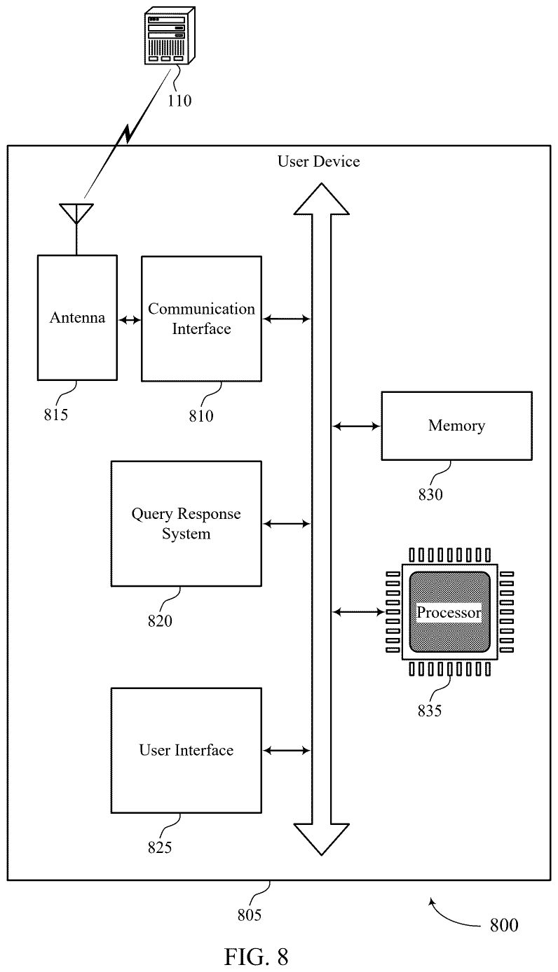

The input interface 610 may manage input signaling for the system 605. For example, the input interface 610 may receive input signaling (e.g., messages, packets, data, instructions, commands, transactions, or any other form of encoded information) from other systems or devices. The input interface 610 may send signaling corresponding to (e.g., representative of or otherwise based on) such input signaling to other components of the system 605 for processing. For example, the input interface 610 may transmit such corresponding signaling to the query response system 620 to support dynamic document retrieval in a RAG system. In some cases, the input interface 610 may be a component of a communication interface 810 as described with reference to FIG. 8.

The output interface 615 may manage output signaling for the system 605. For example, the output interface 615 may receive signaling from other components of the system 605, such as the query response system 620, and may transmit such output signaling corresponding to (e.g., representative of or otherwise based on) such signaling to other systems or devices.

For example, the query response system 620 may include a user query component 625, a data store query component 630, a sorting component 635, a threshold selection component 640, a retrieval response model request component 645, a retrieval response model response component 650, or any combination thereof. In some examples, the query response system 620, or various components thereof, may be configured to perform various operations (e.g., receiving, monitoring, transmitting) using or otherwise in cooperation with the input interface 610, the output interface 615, or both. For example, the query response system 620 may receive information from the input interface 610, send information to the output interface 615, or be integrated in combination with the input interface 610, the output interface 615, or both to receive information, transmit information, or perform various other operations as described herein.

The user query component 625 may be configured as or otherwise support a means for receiving a user query at a query response system. The data store query component 630 may be configured as or otherwise support a means for querying, via one or more data stores storing a corpus of documents, for a plurality of candidate documents associated with the user query. The sorting component 635 may be configured as or otherwise support a means for sorting the plurality of candidate documents based at least in part on respective semantic similarities between each candidate document of the plurality of candidate documents and the user query. The threshold selection component 640 may be configured as or otherwise support a means for selecting a threshold semantic similarity within a range of semantic similarities associated with the sorted plurality of candidate documents, wherein the threshold semantic similarity is selected based at least in part on one or more gradient values between two adjacent respective similarities within the range of semantic similarities and wherein the threshold semantic similarity defines a subset of documents, of the plurality of candidate documents, to be input to a retrieval augmented response model. The retrieval response model request component 645 may be configured as or otherwise support a means for providing, to the retrieval response model, the user query and the subset of the documents defined by the threshold semantic similarity. The retrieval response model response component 650 may be configured as or otherwise support a means for receiving, from the retrieval response model, a response to the user query.

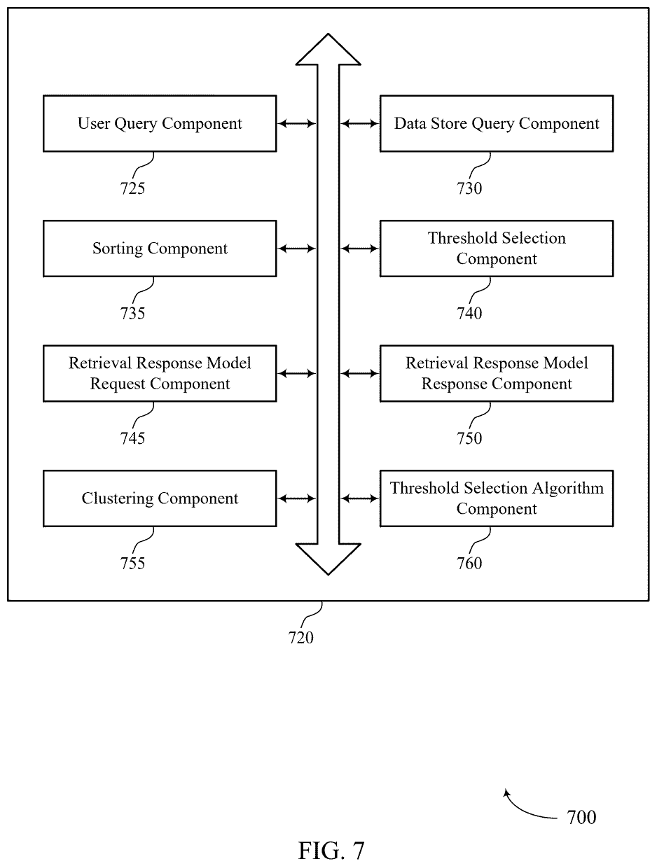

FIG. 7 shows a block diagram 700 of a query response system 720 that supports dynamic document retrieval in a RAG system in accordance with aspects of the present disclosure. The query response system 720 may be an example of aspects of a query response system or a query response system 620, or both, as described herein. The query response system 720, or various components thereof, may be an example of means for performing various aspects of dynamic document retrieval in a RAG system as described herein. For example, the query response system 720 may include a user query component 725, a data store query component 730, a sorting component 735, a threshold selection component 740, a retrieval response model request component 745, a retrieval response model response component 750, a clustering component 755, a threshold selection algorithm component 760, or any combination thereof. Each of these components may communicate, directly or indirectly, with one another (e.g., via one or more buses, communications links, communications interfaces, or any combination thereof).

The user query component 725 may be configured as or otherwise support a means for receiving a user query at a query response system. The data store query component 730 may be configured as or otherwise support a means for querying, via one or more data stores storing a corpus of documents, for a plurality of candidate documents associated with the user query. The sorting component 735 may be configured as or otherwise support a means for sorting the plurality of candidate documents based at least in part on respective semantic similarities between each candidate document of the plurality of candidate documents and the user query. The threshold selection component 740 may be configured as or otherwise support a means for selecting a threshold semantic similarity within a range of semantic similarities associated with the sorted plurality of candidate documents, wherein the threshold semantic similarity is selected based at least in part on one or more gradient values between two adjacent respective similarities within the range of semantic similarities and wherein the threshold semantic similarity defines a subset of documents, of the plurality of candidate documents, to be input to a retrieval augmented response model. The retrieval response model request component 745 may be configured as or otherwise support a means for providing, to the retrieval response model, the user query and the subset of the documents defined by the threshold semantic similarity. The retrieval response model response component 750 may be configured as or otherwise support a means for receiving, from the retrieval response model, a response to the user query.

In some examples, to support selecting the threshold semantic similarity, the threshold selection component 740 may be configured as or otherwise support a means for selecting the threshold semantic similarity based at least in part on a maximum gradient value among gradient values between pairs of adjacent respective similarities within the range of semantic similarities.

In some examples, the maximum gradient value is used for selection of the threshold semantic similarity based at least in part on a quantity of the plurality of candidate documents being below a threshold quantity.

In some examples, the clustering component 755 may be configured as or otherwise support a means for applying a clustering algorithm to a plurality of semantic similarities of the range of semantic similarities, wherein the clustering algorithm generates two or more clusters of one or more candidate documents of the plurality of candidate documents, each of the two or more clusters having semantic similarities within a respective threshold semantic similarity.

In some examples, to support selecting the threshold semantic similarity, the threshold selection component 740 may be configured as or otherwise support a means for selecting the threshold semantic similarity based at least in part on a boundary between two clusters of the two or more clusters of one or more candidate documents.

In some examples, the boundary for the threshold semantic similarity is based at least in part on a maximum difference of semantic similarities between adjacent clusters of the two or more clusters.

In some examples, the response to the user query is associated with a higher accuracy level, generated using reduced processing complexity, or both compared to an accuracy level, a processing complexity, or both of a different response generated using a static threshold semantic similarity.

In some examples, the respective semantic similarities comprise cosine similarities or dot products between respective documents of the plurality of candidate documents and a query embedding of the user query.

In some examples, the threshold selection algorithm component 760 may be configured as or otherwise support a means for selecting a first threshold selection algorithm or a second threshold selection algorithm based at least in part on a quantity of the plurality of candidate documents.

In some examples, the plurality of candidate documents comprise one or more APIs.

In some examples, the retrieval augmented response model is an LLM.

FIG. 8 shows a diagram of a system 800 including a device 805 that supports dynamic document retrieval in a RAG system in accordance with aspects of the present disclosure. The device 805 may be an example of or include components of a system 605 as described herein. The device 805 may include components for dynamic document retrieval in a RAG system including components for transmitting and receiving communications, such as a query response system 820, a communication interface 810, one or more antennas 815, a user interface 825, at least one memory 830, and at least one processor 835. Each of these components may communicate, directly or indirectly, with one another (e.g., via one or more buses, communications links, communications interfaces, or any combination thereof).

The communication interface 810 may manage input and output signals for the device 805 via the antenna 815. For example, the communication interface 810 may enable the user device 805 to exchange information (e.g., input information, output information, or both) with other systems or devices, such as custodial token platform 110 (e.g., supported by one or more servers), via one or more wired or wireless communication links. The communication interface 810 may also utilize or interact with antenna 815 to support communication with other systems or devices. In some cases, the communication interface 810 may represent a physical connection or port to an external peripheral, such as a hardware wallet device. In some cases, the communication interface 810 may utilize an operating system such as iOS®, ANDROID®, MS-DOS®, MS-WINDOWS®, OS/2®, UNIX®, LINUX®, or another known operating system. The communication interface 810 may be implemented as part of the processor 835.

In some cases, the device 805 may include a single antenna 815. However, in some other cases, the device 805 may have more than one antenna 815, which may be capable of concurrently transmitting or receiving multiple wireless transmissions. The communication interface 810 may communicate bi-directionally, via the one or more antennas 815, wired, or wireless links as described herein. For example, the communication interface 810 may represent a wireless transceiver and may communicate bi-directionally with another wireless transceiver. The communication interface 810 may also include a modem to modulate the packets, to provide the modulated packets to one or more antennas 815 for transmission, and to demodulate packets received from the one or more antennas 815.

The user interface 825 may represent a keyboard, a mouse, a touchscreen, a microphone, or a similar device or component. In some cases, a user may interact with the user interface 825. In other cases, the user interface 825 may operate automatically without user interaction. The user interface 825 may display or output information such as information received from other systems or devices or information to be transmitted to other systems or devices.

The memory 830 may include RAM and ROM. The memory 830 may store computer-readable, computer-executable software including instructions that, when executed, cause at least one processor 835 to perform various functions described herein. In some cases, the memory 830 may contain, among other things, a BIOS which may control basic hardware or software operation such as the interaction with peripheral components or devices. The memory 830 may be an example of a single memory or multiple memories. For example, the user device 805 may include one or more memories 830.

The processor 835 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 835 may be configured to operate a memory array using a memory controller. In other cases, a memory controller may be integrated into the processor 835. The processor 835 may be configured to execute computer-readable instructions stored in at least one memory 830 to perform various functions (e.g., functions or tasks supporting a method and system for dynamic document retrieval in a RAG system). Though a single processor 835 is depicted in the example of FIG. 8, it is to be understood that the user device 805 may include any quantity of one or more of processors 835 and that a group of processors 835 may collectively perform one or more functions ascribed herein to a processor, such as the processor 835. The processor 835 may be an example of a single processor or multiple processors. For example, the device 805 may include one or more processors 835.

For example, the query response system 820 may be configured as or otherwise support a means for receiving a user query at a query response system. The query response system 820 may be configured as or otherwise support a means for querying, via one or more data stores storing a corpus of documents, for a plurality of candidate documents associated with the user query. The query response system 820 may be configured as or otherwise support a means for sorting the plurality of candidate documents based at least in part on respective semantic similarities between each candidate document of the plurality of candidate documents and the user query. The query response system 820 may be configured as or otherwise support a means for selecting a threshold semantic similarity within a range of semantic similarities associated with the sorted plurality of candidate documents, wherein the threshold semantic similarity is selected based at least in part on one or more gradient values between two adjacent respective similarities within the range of semantic similarities and wherein the threshold semantic similarity defines a subset of documents, of the plurality of candidate documents, to be input to a retrieval augmented response model. The query response system 820 may be configured as or otherwise support a means for providing, to the retrieval response model, the user query and the subset of the documents defined by the threshold semantic similarity. The query response system 820 may be configured as or otherwise support a means for receiving, from the retrieval response model, a response to the user query.

By including or configuring the query response system 820 in accordance with examples as described herein, the device 805 may support techniques for improved accuracy of responses generated by an LLM, reduced computational complexity and resource utilization, or both in accordance with increased relevance of input documents supported by dynamic document retrieval.

The query response system 820 may include an application (e.g., “app”), program, software, extension, or other component which is configured to facilitate communications with a custodial token platform 110 on a server, one or more nodes of a blockchain network 105, other user devices 805, and other devices or systems. For example, the query response system 820 may be an application executable on the user device 805, and the query response system 820 may be configured to receive data from a custodial token platform 110, transmit data to the custodial token platform 110, process such data, and cause presentation of such data to a user via a user interface 825. The query response system 820 may be an example of a wallet application, a wallet device, or both, and may be associated with a wallet address and may access or use a private key to sign messages to facilitate transfer of crypto tokens, messages, transactions, or the like via a blockchain distributed data store.

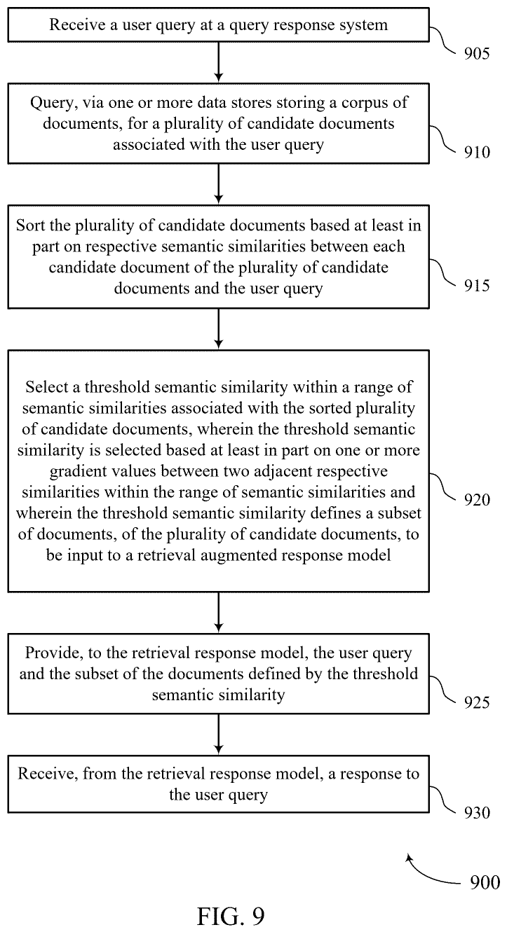

FIG. 9 shows a flowchart illustrating a method 900 that supports dynamic document retrieval in a RAG system in accordance with aspects of the present disclosure. The operations of the method 900 may be implemented by a RAG system or its components as described herein. For example, the operations of the method 900 may be performed by a RAG system as described with reference to FIGS. 1 through 8. In some examples, a RAG system may execute a set of instructions to control the functional elements of the RAG system to perform the described functions. Additionally, or alternatively, the RAG system may perform aspects of the described functions using special-purpose hardware.

At 905, the method may include receiving a user query at a query response system. The operations of 905 may be performed in accordance with examples as disclosed herein. In some examples, aspects of the operations of 905 may be performed by a user query component 725 as described with reference to FIG. 7.

At 910, the method may include querying, via one or more data stores storing a corpus of documents, for a plurality of candidate documents associated with the user query. The operations of 910 may be performed in accordance with examples as disclosed herein. In some examples, aspects of the operations of 910 may be performed by a data store query component 730 as described with reference to FIG. 7.

At 915, the method may include sorting the plurality of candidate documents based at least in part on respective semantic similarities between each candidate document of the plurality of candidate documents and the user query. The operations of 915 may be performed in accordance with examples as disclosed herein. In some examples, aspects of the operations of 915 may be performed by a sorting component 735 as described with reference to FIG. 7.

At 920, the method may include selecting a threshold semantic similarity within a range of semantic similarities associated with the sorted plurality of candidate documents, wherein the threshold semantic similarity is selected based at least in part on one or more gradient values between two adjacent respective similarities within the range of semantic similarities and wherein the threshold semantic similarity defines a subset of documents, of the plurality of candidate documents, to be input to a retrieval augmented response model. The operations of 920 may be performed in accordance with examples as disclosed herein. In some examples, aspects of the operations of 920 may be performed by a threshold selection component 740 as described with reference to FIG. 7.

At 925, the method may include providing, to the retrieval response model, the user query and the subset of the documents defined by the threshold semantic similarity. The operations of 925 may be performed in accordance with examples as disclosed herein. In some examples, aspects of the operations of 925 may be performed by a retrieval response model request component 745 as described with reference to FIG. 7.

At 930, the method may include receiving, from the retrieval response model, a response to the user query. The operations of 930 may be performed in accordance with examples as disclosed herein. In some examples, aspects of the operations of 930 may be performed by a retrieval response model response component 750 as described with reference to FIG. 7.

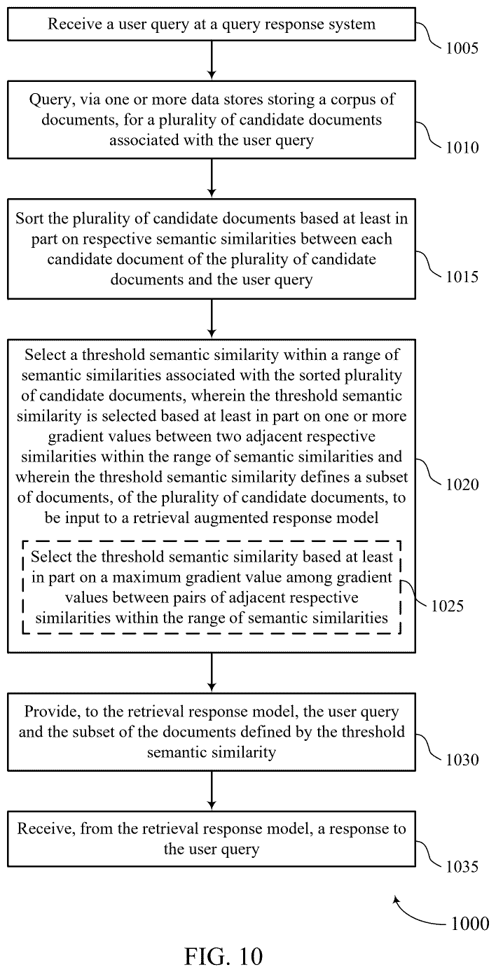

FIG. 10 shows a flowchart illustrating a method 1000 that supports dynamic document retrieval in a RAG system in accordance with aspects of the present disclosure. The operations of the method 1000 may be implemented by a RAG system or its components as described herein. For example, the operations of the method 1000 may be performed by a RAG system as described with reference to FIGS. 1 through 8. In some examples, a RAG system may execute a set of instructions to control the functional elements of the RAG system to perform the described functions. Additionally, or alternatively, the RAG system may perform aspects of the described functions using special-purpose hardware.

At 1005, the method may include receiving a user query at a query response system. The operations of 1005 may be performed in accordance with examples as disclosed herein. In some examples, aspects of the operations of 1005 may be performed by a user query component 725 as described with reference to FIG. 7.

At 1010, the method may include querying, via one or more data stores storing a corpus of documents, for a plurality of candidate documents associated with the user query. The operations of 1010 may be performed in accordance with examples as disclosed herein. In some examples, aspects of the operations of 1010 may be performed by a data store query component 730 as described with reference to FIG. 7.

At 1015, the method may include sorting the plurality of candidate documents based at least in part on respective semantic similarities between each candidate document of the plurality of candidate documents and the user query. The operations of 1015 may be performed in accordance with examples as disclosed herein. In some examples, aspects of the operations of 1015 may be performed by a sorting component 735 as described with reference to FIG. 7.

At 1020, the method may include selecting a threshold semantic similarity within a range of semantic similarities associated with the sorted plurality of candidate documents, wherein the threshold semantic similarity is selected based at least in part on one or more gradient values between two adjacent respective similarities within the range of semantic similarities and wherein the threshold semantic similarity defines a subset of documents, of the plurality of candidate documents, to be input to a retrieval augmented response model. The operations of 1020 may be performed in accordance with examples as disclosed herein. At 1025, selecting the threshold semantic similarity may include selecting the threshold semantic similarity based at least in part on a maximum gradient value among gradient values between pairs of adjacent respective similarities within the range of semantic similarities. The operations of 1020 and 1025 may be performed in accordance with examples as disclosed herein. In some examples, aspects of the operations of 1020 and 1025 may be performed by a threshold selection component 740 as described with reference to FIG. 7.

At 1030, the method may include providing, to the retrieval response model, the user query and the subset of the documents defined by the threshold semantic similarity. The operations of 1030 may be performed in accordance with examples as disclosed herein. In some examples, aspects of the operations of 1030 may be performed by a retrieval response model request component 745 as described with reference to FIG. 7.

At 1035, the method may include receiving, from the retrieval response model, a response to the user query. The operations of 1035 may be performed in accordance with examples as disclosed herein. In some examples, aspects of the operations of 1035 may be performed by a retrieval response model response component 750 as described with reference to FIG. 7.

A method by an apparatus is described. The method may include receiving a user query at a query response system, querying, via one or more data stores storing a corpus of documents, for a plurality of candidate documents associated with the user query, sorting the plurality of candidate documents based at least in part on respective semantic similarities between each candidate document of the plurality of candidate documents and the user query, selecting a threshold semantic similarity within a range of semantic similarities associated with the sorted plurality of candidate documents, wherein the threshold semantic similarity is selected based at least in part on one or more gradient values between two adjacent respective similarities within the range of semantic similarities and wherein the threshold semantic similarity defines a subset of documents, of the plurality of candidate documents, to be input to a retrieval augmented response model, providing, to the retrieval response model, the user query and the subset of the documents defined by the threshold semantic similarity, and receiving, from the retrieval response model, a response to the user query.

An apparatus is described. The apparatus may include one or more memories storing processor executable code, and one or more processors coupled with the one or more memories. The one or more processors may individually or collectively be operable to execute the code to cause the apparatus to receive a user query at a query response system, query, via one or more data stores storing a corpus of documents, for a plurality of candidate documents associated with the user query, sort the plurality of candidate documents based at least in part on respective semantic similarities between each candidate document of the plurality of candidate documents and the user query, select a threshold semantic similarity within a range of semantic similarities associated with the sorted plurality of candidate documents, wherein the threshold semantic similarity is selected based at least in part on one or more gradient values between two adjacent respective similarities within the range of semantic similarities and wherein the threshold semantic similarity defines a subset of documents, of the plurality of candidate documents, to be input to a retrieval augmented response model, provide, to the retrieval response model, the user query and the subset of the documents defined by the threshold semantic similarity, and receive, from the retrieval response model, a response to the user query.

Another apparatus is described. The apparatus may include means for receiving a user query at a query response system, means for querying, via one or more data stores storing a corpus of documents, for a plurality of candidate documents associated with the user query, means for sorting the plurality of candidate documents based at least in part on respective semantic similarities between each candidate document of the plurality of candidate documents and the user query, means for selecting a threshold semantic similarity within a range of semantic similarities associated with the sorted plurality of candidate documents, wherein the threshold semantic similarity is selected based at least in part on one or more gradient values between two adjacent respective similarities within the range of semantic similarities and wherein the threshold semantic similarity defines a subset of documents, of the plurality of candidate documents, to be input to a retrieval augmented response model, means for providing, to the retrieval response model, the user query and the subset of the documents defined by the threshold semantic similarity, and means for receiving, from the retrieval response model, a response to the user query.

A non-transitory computer-readable medium storing code is described. The code may include instructions executable by one or more processors to receive a user query at a query response system, query, via one or more data stores storing a corpus of documents, for a plurality of candidate documents associated with the user query, sort the plurality of candidate documents based at least in part on respective semantic similarities between each candidate document of the plurality of candidate documents and the user query, select a threshold semantic similarity within a range of semantic similarities associated with the sorted plurality of candidate documents, wherein the threshold semantic similarity is selected based at least in part on one or more gradient values between two adjacent respective similarities within the range of semantic similarities and wherein the threshold semantic similarity defines a subset of documents, of the plurality of candidate documents, to be input to a retrieval augmented response model, provide, to the retrieval response model, the user query and the subset of the documents defined by the threshold semantic similarity, and receive, from the retrieval response model, a response to the user query.

In some examples of the method, apparatus, and non-transitory computer-readable medium described herein, selecting the threshold semantic similarity may include operations, features, means, or instructions for selecting the threshold semantic similarity based at least in part on a maximum gradient value among gradient values between pairs of adjacent respective similarities within the range of semantic similarities.

In some examples of the method, apparatus, and non-transitory computer-readable medium described herein, the maximum gradient value may be used for selection of the threshold semantic similarity based at least in part on a quantity of the plurality of candidate documents being below a threshold quantity.

Some examples of the method, apparatus, and non-transitory computer-readable medium described herein may further include operations, features, means, or instructions for applying a clustering algorithm to a plurality of semantic similarities of the range of semantic similarities, wherein the clustering algorithm generates two or more clusters of one or more candidate documents of the plurality of candidate documents, each of the two or more clusters having semantic similarities within a respective threshold semantic similarity.

In some examples of the method, apparatus, and non-transitory computer-readable medium described herein, selecting the threshold semantic similarity may include operations, features, means, or instructions for selecting the threshold semantic similarity based at least in part on a boundary between two clusters of the two or more clusters of one or more candidate documents.

In some examples of the method, apparatus, and non-transitory computer-readable medium described herein, the boundary for the threshold semantic similarity may be based at least in part on a maximum difference of semantic similarities between adjacent clusters of the two or more clusters.

In some examples of the method, apparatus, and non-transitory computer-readable medium described herein, the response to the user query may be associated with a higher accuracy level, generated using reduced processing complexity, or both compared to an accuracy level, a processing complexity, or both of a different response generated using a static threshold semantic similarity.

In some examples of the method, apparatus, and non-transitory computer-readable medium described herein, the respective semantic similarities comprise cosine similarities or dot products between respective documents of the plurality of candidate documents and a query embedding of the user query.

Some examples of the method, apparatus, and non-transitory computer-readable medium described herein may further include operations, features, means, or instructions for selecting a first threshold selection algorithm or a second threshold selection algorithm based at least in part on a quantity of the plurality of candidate documents.

In some examples of the method, apparatus, and non-transitory computer-readable medium described herein, the plurality of candidate documents comprise one or more APIs.

In some examples of the method, apparatus, and non-transitory computer-readable medium described herein, the retrieval augmented response model may be an LLM.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method of data processing, comprising:
receiving a user query at a query response system;
querying, via one or more data stores storing a corpus of documents, for a plurality of candidate documents associated with the user query;
sorting the plurality of candidate documents based at least in part on respective semantic similarities between each candidate document of the plurality of candidate documents and the user query;
selecting a threshold semantic similarity within a range of semantic similarities associated with the sorted plurality of candidate documents, wherein the threshold semantic similarity is selected based at least in part on one or more gradient values between two adjacent respective similarities within the range of semantic similarities;
selecting, based at least in part on the threshold semantic similarity, a subset of documents, of the plurality of candidate documents, to be input to a retrieval augmented response model;
providing, to the retrieval augmented response model, the user query and the subset of the documents defined by the threshold semantic similarity; and
receiving, from the retrieval augmented response model, a response to the user query.

2. The method of claim 1, wherein selecting the threshold semantic similarity comprises:
selecting the threshold semantic similarity based at least in part on a maximum gradient value among gradient values between pairs of adjacent respective similarities within the range of semantic similarities.

3. The method of claim 2, wherein the maximum gradient value is used for selection of the threshold semantic similarity based at least in part on a quantity of the plurality of candidate documents being below a threshold quantity.

4. The method of claim 1, further comprising:
applying a clustering algorithm to a plurality of semantic similarities of the range of semantic similarities, wherein the clustering algorithm generates two or more clusters of one or more candidate documents of the plurality of candidate documents, each of the two or more clusters having semantic similarities within a respective threshold semantic similarity.

5. The method of claim 4, wherein selecting the threshold semantic similarity comprises:
selecting the threshold semantic similarity based at least in part on a boundary between two clusters of the two or more clusters of one or more candidate documents.

6. The method of claim 5, wherein the boundary for the threshold semantic similarity is based at least in part on a maximum difference of semantic similarities between adjacent clusters of the two or more clusters.

7. The method of claim 1, wherein the response to the user query is associated with a higher accuracy level, generated using reduced processing complexity, or both compared to an accuracy level, a processing complexity, or both of a different response generated using a static threshold semantic similarity.

8. The method of claim 1, wherein the respective semantic similarities comprise cosine similarities or dot products between respective documents of the plurality of candidate documents and a query embedding of the user query.

9. The method of claim 1, further comprising:
selecting a first threshold selection algorithm or a second threshold selection algorithm based at least in part on a quantity of the plurality of candidate documents.

10. The method of claim 1, wherein the plurality of candidate documents comprise one or more application programming interfaces (APIs).

11. The method of claim 1, wherein the retrieval augmented response model is a large language model (LLM).

12. An apparatus, comprising:
one or more memories storing processor-executable code; and
one or more processors coupled with the one or more memories and individually or collectively operable to execute the code to cause the apparatus to:
receive a user query at a query response system;
query, via one or more data stores storing a corpus of documents, for a plurality of candidate documents associated with the user query;
sort the plurality of candidate documents based at least in part on respective semantic similarities between each candidate document of the plurality of candidate documents and the user query;
select a threshold semantic similarity within a range of semantic similarities associated with the sorted plurality of candidate documents, wherein the threshold semantic similarity is selected based at least in part on a maximum gradient value among gradient values between pairs of adjacent respective similarities within the range of semantic similarities;
select, based at least in part on the threshold semantic similarity, a subset of documents, of the plurality of candidate documents, to be input to a retrieval augmented response model;
provide, to the retrieval augmented response model, the user query and the subset of the documents defined by the threshold semantic similarity; and
receive, from the retrieval augmented response model, a response to the user query.

13. The apparatus of claim 12, wherein the maximum gradient value is used for selection of the threshold semantic similarity based at least in part on a quantity of the plurality of candidate documents being below a threshold quantity.

14. The apparatus of claim 12, wherein the response to the user query is associated with a higher accuracy level, generated using reduced processing complexity, or both compared to an accuracy level, a processing complexity, or both of a different response generated using a static threshold semantic similarity.

15. The apparatus of claim 12, wherein the respective semantic similarities comprise cosine similarities or dot products between respective documents of the plurality of candidate documents and a query embedding of the user query.

16. A non-transitory computer-readable medium storing code, the code comprising instructions executable by one or more processors to:
receive a user query at a query response system;
query, via one or more data stores storing a corpus of documents, for a plurality of candidate documents associated with the user query;
sort the plurality of candidate documents based at least in part on respective semantic similarities between each candidate document of the plurality of candidate documents and the user query;
apply a clustering algorithm to a plurality of semantic similarities of a range of semantic similarities, wherein the clustering algorithm generates two or more clusters of one or more candidate documents of the plurality of candidate documents, each of the two or more clusters having semantic similarities within a respective threshold semantic similarity;
select a threshold semantic similarity between adjacent clusters of the two or more clusters;
selecting, based at least in part on the threshold semantic similarity, a subset of documents, of the plurality of candidate documents, to be input to a retrieval augmented response model;
provide, to the retrieval augmented response model, the user query and the subset of the documents defined by the threshold semantic similarity; and
receive, from the retrieval augmented response model, a response to the user query.

17. The non-transitory computer-readable medium of claim 16, wherein the instructions to select the threshold semantic similarity are executable by the one or more processors to:
select the threshold semantic similarity based at least in part on a boundary between two clusters of the two or more clusters of one or more candidate documents.

18. The non-transitory computer-readable medium of claim 17, wherein the boundary for the threshold semantic similarity is based at least in part on a maximum difference of semantic similarities between adjacent clusters of the two or more clusters.

19. The non-transitory computer-readable medium of claim 16, wherein the response to the user query is associated with a higher accuracy level, generated using reduced processing complexity, or both compared to an accuracy level, a processing complexity, or both of a different response generated using a static threshold semantic similarity.

20. The non-transitory computer-readable medium of claim 16, wherein the respective semantic similarities comprise cosine similarities or dot products between respective documents of the plurality of candidate documents and a query embedding of the user query.

21. The method of claim 1, further comprising:
processing, at the retrieval augmented response model, the user query and the subset of documents defined by the threshold semantic similarity to generate the response to the user query.
